(19) United States
(12) Patent Application Publication
(10) Pub. No.: US 2006/0183437 A1
(43) Pub. Date: Aug. 17, 2006

(54) Circuit arrangement for a mobile radio device

(75) Inventor: Rainer Pietig, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/549,558

(22) PCT Filed: Mar. 15, 2004
(86) PCT No.: PCT/IB04/00798

§ 371 Date: Sep. 19, 2005

(30) Foreign Application Priority Data
Mar. 21, 2003 (EP) 03100735.4

(51) Int. Cl. H04B 1/02

(52) U.S. Cl. 455/101

(57) ABSTRACT

The invention relates to a circuit arrangement for a mobile radio device comprising a power divider (1) for dividing a high-frequency transmit signal over at least two antennas (2,3( spatially arranged mutually apart and comprising at least one phase shifter (4) connected between one of the antennas (2, 3) and the power divider (1) for generating a phase difference (Δ) between the transmit signals radiated by the antennas (2, 3). To achieve a directional characteristic in the transmit mode of the mobile radio device with at the same time an non-directional sensitivity in the receive mode, the invention proposes for the phase shifter(4) to be arranged as a non-reciprocal phase shifter, so that high-frequency receive signals received from the antennas (2, 3) are applied to the power divider (1) with out a phase difference.

The invention relates to a circuit arrangement for a mobile radio device comprising a power divider for dividing a high-frequency transmit signal over at least two antennas spatially arranged mutually apart and comprising at least one phase shifter connected between one of the antennas and the power divider for generating a phase difference between the transmit signals radiated by the antennas.

It is known that in conventional mobile radio devices a considerable part of the microwave radiation produced in the transmit mode of these devices is absorbed in the body of a user of the mobile radio device, more particularly in his head. Admittedly, adverse effects on the user's health caused by the microwave radiation in the power range of mobile radio devices have not been demonstrated up to now. Nevertheless, it is desirable that by suitably arranged technical measures the mobile radio devices be arranged such that the specific absorption ratio (SAR) of the microwave radiation in the body of the user of the mobile radio device is kept smallest possible.

In order to reach a smallest possible user burden with microwave radiation, for example the directional characteristic of the antenna of the mobile radio device can be arranged such that the least possible power is radiated in the direction of the user. To this end, the mobile radio device is known to be fitted out with a screen plate which is located between the antenna of the mobile radio device and the user's head.

A disadvantage is then that the directional characteristic of the screen plate also works in the receive mode of the mobile radio device, so that the reception can be affected in dependence on the instantaneous orientation of the device.

To achieve a certain directional characteristic with mobile radio antennas, a certain spatial arrangement of a plurality of antennas can be used as known from AT 405 348 B, where the individual antennas are supplied with the high-frequency transmit signal with predefinable phase differences. To this end the high-frequency transmit signal is divided by means of a power divider. The desired phase differences are produced in that each time a phase shifter is connected between antenna and power divider.

Also disadvantageous in this known arrangement is that the directional characteristic, which protects the user of the mobile radio device in the transmit mode, rather has an interfering effect in the receive mode. It is conceivable in principle to use a separate receiving antenna without a special directional characteristic in addition to an antenna array exclusively meant for the transmit mode and which has a desired directional characteristic. But, on the one hand, for reasons of cost and, on the other hand, for reasons of space this is out of the question considering the miniaturization strived for with mobile radio devices. In practice it is impossible to sufficiently miniaturize such an antenna array that has the desired directional characteristic in the transmit mode and at the same time a sufficient bandwidth for third-generation mobile radio devices.

Based on this idea the present invention has for an object to provide a circuit arrangement for a mobile radio device by which a directional characteristic protecting the user of the mobile radio device is achieved exclusively in the transmit mode of the mobile radio device, whereas in the receive mode there is a non-directional characteristic. The circuit arrangement is then to end up without a separate antenna for the transmit or receive mode respectively, and it should be possible to realize such an arrangement cost effectively and economically.

This object is achieved by a circuit arrangement of the type defined in the opening paragraph in that the phase shifter is arranged as a non-reciprocal phase shifter, so that high-frequency receive signals received from the antennas are applied to the power divider without a phase difference.

In the transmit mode the power divider of the circuit arrangement according to the invention divides the microwave signal radiated by the mobile radio device into two or more signals each having a reduced power level. These signals are then applied to the individual antennas which are arranged in a specific way in the mobile radio device spatially apart. The desired directional characteristic is then achieved in that between at least one of the antennas and the power divider a phase shifter is connected by which a certain phase difference is produced between the transmit signals radiated by the antennas. The extent of the phase difference and the spatial arrangement of the antennas in the mobile radio device are to be exactly tuned to each other, so that the desired directional characteristic in the transmit mode is achieved.

In the receive mode the high-frequency receive signals received from the antennas are again applied to the power divider, which superimposes the receive signals on a sum signal. This sum signal is then applied to the respective components of the mobile radio device for further processing. As a result of the fact that according to the invention a non-reciprocal phase shifter is used for generating the transmit-mode-required phase difference between the transmit signals radiated by the antennas, it is achieved that the receive signals which are superimposed in the receive mode by means of the power divider, do not have a phase difference. The result is that the mobile radio device does not have a particular directional characteristic in the receive mode, which advantageously leads to the fact that the reception of the mobile radio device does not depend on its instantaneous orientation. At the same time, however, the user of the mobile radio device is safeguarded from too high a load of microwave radiation in the transmit mode.

The circuit according to the invention may advantageously be manufactured extremely cost effectively with only a few standard components. Already with two dipole antennas of conventional type a directional characteristic suitable for the transmit mode can be achieved, so that the circuit arrangement according to the invention occupies only minimum space inside the mobile radio device.

If the antennas are dipole antennas, the dipole axes of the antennas are expediently to be aligned parallel to each other, while the distance between the antennas is then to be smaller than the wavelength of the transmit and receive signals. At the same time the phase difference between the transmit signals radiated by the antennas, which difference is generated by the non-reciprocal phase shifter is to be 180° at the most. In this way a directional characteristic can be achieved cost-effectively in the transmit mode of the mobile radio device in which the microwave power radiated to the user is strongly reduced and in which at the same time there is no too strong concentration in the radiation direction away from the user. The latter is important to guarantee that the signals radiated by the mobile radio device in the transmit mode possibly independent of the instantaneous orientation of the mobile radio device can be received sufficiently well, so that no restrictions exist in the use of the mobile radio device. It has appeared that a particularly suitable directional characteristic will be obtained if the distance between the antennas is equal to one or two tenths of the wavelength of the transmit mode and receive signals and the phase difference between the transmit signals radiated by the antennas is about 100° to 145°.

The previously described circuit arrangement can be installed at little cost as a transmit mode/receive module for a conventional type of mobile radio device. If the antennas of the mobile radio device are dipole antennas whose dipole axes are aligned parallel to each other, the antennas are to be arranged at different distances from the user's head to effectively protect the user of the mobile radio device. For example, dipole antennas may be positioned at a suitable distance along an axis pointing away from the user's head.

Examples of embodiment of the invention will be further explained in the following with reference to the Figures in which:

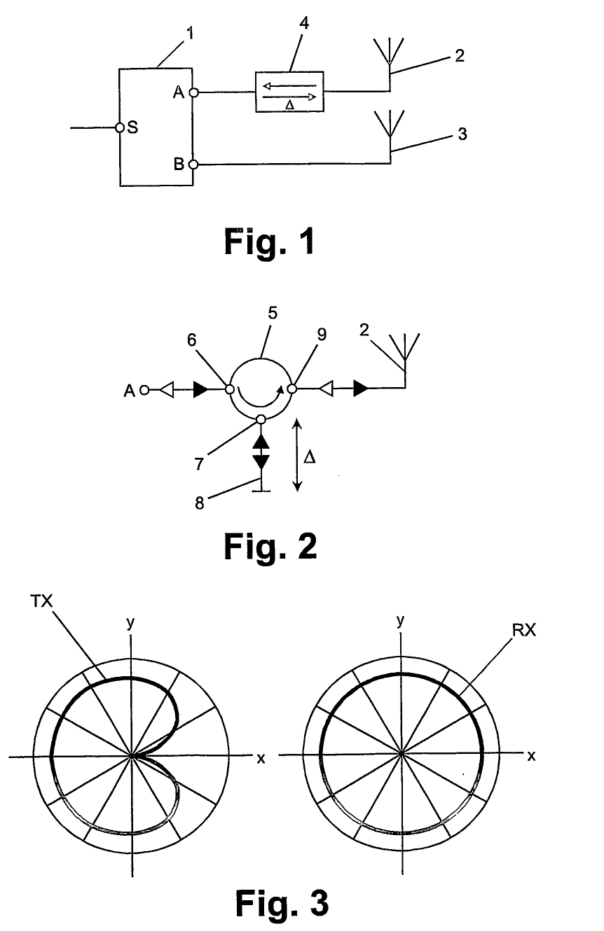

FIG. 1 shows a block diagram of the circuit arrangement according to the invention,

FIG. 2 shows non-reciprocal phase shifters that can be used for the circuit arrangement according to the invention and

FIG. 3 shows directional diagrams of the mobile radio device according to the invention.

The circuit arrangement shown in FIG. 1 comprises a power divider 1 with a high-frequency transmit signal being fed to its input S. By means of the power divider 1 the transmit signal is divided into two signals of less power which are present on the outputs A and B of the power divider 1. These signals are applied to two antennas 2 and 3 arranged spatially apart. Between the antennas 2 and the power divider 1 is connected a non-reciprocal phase shifter 4 for producing a phase difference A between the transmit signals radiated by the antennas 2 and 3. The spatial arrangement of the two antennas 2 and 3 as well as the amount of the phase difference A determines the directional characteristic of the arrangement in the transmit mode. High-frequency receive signals received by the antennas 2 and 3 are applied to the power divider 1 via its terminals A and B. The power divider 1 superimposes these signals on a sum signal which is present on the terminal S of the power divider 1. The signal received from the antenna 2 undergoes no phase shift as a result of the non-reciprocal phase shifter so that the receive signals are superimposed in phase by the power divider 1. For this reason there is no directional characteristic whatsoever in the receive mode of the circuit arrangement shown. The sensitivity on reception is equally large in all directions in space.

FIG. 2 shows a manufacturing possibility of a non-reciprocal phase shifter. The phase shifter shown comprises a three-port circulator 5 whose port 6 is connected to connection A of the power divider. The transmit signal applied to the circulator 5 is applied to a conductive element 8 via the port 7 of the circulator. At the end of the conductive element 8 there is a reflection of the transmit signal, so that the reflected transmit signal is cast back to the port 7 of the circulator 5 while it has undergone a phase shift Δ which depends on the length of the conductive element 8. The phase-shifted transmit signal is then output on port 9 of the circulator 5 and applied to the antenna 2. Signals received by the antenna 2 are directly transmitted from the port 9 of the circulator 5 to its port 6 without a phase shift being realized.

The left diagram of FIG. 3 shows the directional characteristic of a mobile radio device in the transmit mode equipped with the circuit arrangement shown in FIG. 1.

The right diagram shows the directional characteristic of the same device in the receive mode. Along the contour TX the microwaves radiated by the mobile radio device have the same amplitudes. The contour RX clarifies the receive mode sensitivity of the mobile radio device which is in essence equally large in all directions in space. The directional characteristic shown in the left diagram can be achieved with two dipole antennas whose dipole axes are arranged in z direction, which means perpendicularly to the level of presentation.

At the same time the antennas are arranged mutually apart in x direction where the distance between the antennas is about 1/10 of the wavelength of the transmit signal. The phase difference between the transmit signals radiated by the two antennas is about 145°. By means of the left directional diagram it is clearly visible that more power is radiated to the left than to the right by the antenna array provided in the center of the diagram. The head of the user of the mobile radio device is thus sensibly to be located on the right of the antenna array.

1. A circuit arrangement for a mobile radio device comprising a power divider (1) for dividing a high-frequency transmit signal over at least two antennas (2, 3) spatially arranged mutually apart and comprising at least one phase shifter (4) connected between one of the antennas (2) and the power divider (1) for generating a phase difference (Δ) between the transmit signals radiated by the antennas (2, 3), characterized in that the phase shifter (4) is arranged as a non-reciprocal phase shifter, so that high-frequency receive signals received from the antennas (2, 3) are applied to the power divider (1) without a phase difference.

2. A circuit arrangement as claimed in claim 1, characterized in that the antennas (2, 3) are dipole antennas.

3. A circuit arrangement as claimed in claim 2, characterized in that the dipole axes of the antennas (2, 3) are aligned parallel to each other.

4. A circuit arrangement as claimed in claim 1, characterized in that the distance between the antennas (2, 3) is smaller than the wavelength of the transmit mode and receive signals and in that the phase difference (Δ) between the transmit signals radiated by the antennas (2, 3) is 1800 at the most.

5. A circuit arrangement as claimed in claim 4, characterized in that the distance between the antennas (2, 3) corresponds to one or two tenths of the wavelength of the transmit mode and receive signals and in that the phase difference (Δ) between the transmit signals radiated by the antennas (2, 3) is 100° to 145°.

6. A mobile radio device comprising a transmit mode/receive module which includes a power divider (1) for dividing a high-frequency transmit signal over at least two antennas (2, 3) of the mobile radio device which are spatially arranged mutually apart where a phase shifter (4) for generating a phase difference (Δ) between the transmit signals radiated by the antennas (2, 3) is connected between one of the antennas (2) and the power divider (1), characterized in that the phase shifter (4) is arranged as a non-reciprocal phase shifter, so that high-frequency receive signals received from the antennas (2, 3) are applied to the power divider (1) without a phase difference.

7. A mobile radio device as claimed in claim 6, characterized in that the antennas (2, 3) of the mobile radio device are dipole antennas whose dipole axes are aligned parallel to each other.

8. A mobile radio device as claimed in claim 7, characterized in that the antennas (2, 3) of the mobile radio device are arranged at different distances from the head of a user of the mobile radio device.
